(19) United States
(12) Patent Application Publication
(10) Pub. No.: US 2021/0073752 A1
(43) Pub. Date: Mar. 11, 2021

(54) Method, device and program for managing proofs of purchase

(71) Applicant: ORANGE, Paris (FR)

(72) Inventors: Emmanuel Le Huerou, Chatillon Cedex (FR); Francois Toutain, Chatillon Cedex (FR)

(21) Appl. No.: 16/956,120

(22) PCT Filed: Dec. 17, 2018
(86) PCT No.: PCT/FR2018/053331

§ 371 Date: Jun. 19, 2020

(30) Foreign Application Priority Data
Dec. 22, 2017 (FR) 1763004

(51) Int. Cl. G06Q 20/04; G06Q 20/40; G06Q 40/02; G06F 16/9035

(52) U.S. Cl. CPC G06Q 20/047; G06F 16/9035; G06Q 40/02; G06Q 20/401

(57) ABSTRACT

A method for managing proofs of purchase, which includes: collecting at least one proof of purchase; extracting at least one characteristic of the purchase from the at least one proof of purchase collected; identifying a bank transaction on a bank account of the user by matching the at least one characteristic of the extracted proof of purchase with a characteristic of a transaction on a bank account of the user; and, when a transaction is identified, storing the proof of purchase associated with the transaction in a database.

### TECHNICAL FIELD

The invention is in the field of telecommunications and in particular relates to a system for managing proofs of purchase.

### PRIOR ART

Each expenditure in a trader's premises is accompanied by a proof of purchase, such as for example a till receipt, an invoice, a guarantee or any other form of receipt.

In 2015, 70% of French people prefer to pay for their purchases by bank card rather than by cash or by cheque. Thus, each purchase gives rise to the issue of a bank card slip and a till receipt.

Such proofs rapidly accumulate in the users' wallets up to the point where looking for a particular proof is time-consuming when the user wishes for example to return an item and where a proof of purchase is necessary. In fact, the necessary till receipt can be among other similar receipts in a wallet, or a handbag or it can still be at the bottom of a shopping bag, or it can simply have been thrown away. Thus, the management of such proofs of purchase is not easy.

Various solutions based on digital communication technologies have been proposed. For example, more and more shops are offering their customers paperless till receipts accessible on a customer account or sent by email after checking out. Such systems are often linked with a loyalty card making it possible to quickly identify the customer in order to send him the proof of purchase. However, such practices are not widespread and they involve the creation of a loyalty card for the user that the user may not want. The proofs of purchase supplied to the customer by the various shops visited by the customer are therefore heterogeneous: a portion of the receipts consists of paper receipts, whilst another portion of the proofs of purchase is available online, on an internet site belonging to the brand or on his electronic messaging system. Thus, when a user is looking for a particular receipt, he must remember the nature of the proof of purchase that was given to him in order to search among the available paper receipts, or on a particular internet site, or on his electronic messaging system. Such a search often represents a waste of time for the user. The management of proofs of purchase is therefore not always optimal.

The current systems for managing proofs of purchase also have disadvantages when it is a matter of accounting for the spending operations performed and/or of sorting them by category. In fact, it is long and tedious for a user to group the spending operations per object on the basis of till receipts.

There is therefore a need for a method of managing proofs of purchase which does not exhibit the disadvantages of the prior art.

### SUMMARY OF THE INVENTION

For this purpose, there is proposed a method for managing proofs of purchase comprising the steps of:
Collecting at least one proof of purchase,
Extracting at least one characteristic of the purchase from the at least one proof of purchase collected,
Identifying a bank transaction on a bank account of the user by matching the at least one extracted characteristic of the proof of purchase with a characteristic of a bank transaction on a bank account of the user,
When a transaction is identified, storing the proof of purchase in association with the transaction in a database.

The method thus makes it possible to collect proofs of purchases made by a user, such as receipts or till receipts, and to match them with bank transactions recorded on the bank account of the user before transmitting them to the terminal of the user. The method thus facilitates the managing of proofs of purchase notably by making it possible to associate them with the corresponding bank transaction before transmitting them to a terminal of the user.

In this way, the method makes it possible to carry out groupings of proofs of purchase according to a criterion extracted from a proof of purchase. For example, proofs of purchases made in a same shop can be grouped according to the name of the shop such as it appears on the proof of purchase. It is advantageous to produce groups of proofs of purchase based on a characteristic comprised in a proof of purchase rather than groups based on characteristics of bank transactions. In fact, the proofs of purchase often provide more information relating to the transaction than does the transaction recorded on a bank account.

The proofs of purchase are for example collected from one or more databases in which proofs of purchase transmitted by a checkout system or a user's terminal such as a smartphone are stored in an electronic form.

In the context of the invention, a proof of purchase is understood to mean any document relative to a transaction, such as for example a till receipt, a warranty card, a discount coupon or any other receipt.

According to a particular embodiment, the management method comprises moreover a step of transmission, to a storage entity, of a characteristic of the transaction and of a representation of the associated proof of purchase.

The storage entity is for example a user's terminal. In this way, when the method is used by a server, a representation of the proof of purchase is transmitted to a terminal of the user. When the method is used by a terminal, such as for example a user's smartphone, the proof of purchase is transmitted to a server allowing it to be stored in association with the corresponding bank transaction.

According to a particular embodiment, the method is such that the transmission step comprises the transmission of a message according to an instant messaging protocol.

In this way, an electronic version of a receipt is received by a user on his terminal immediately after a payment made in a shop. The use of an instant messaging system for transmitting the proofs of purchase improves the interactivity, the proof of purchase being able to be received by a user's terminal immediately after a purchase.

According to a particular embodiment, the instant message transmitted to the storage entity comprises a grouping criterion determined according to the at least one characteristic extracted from the proof of purchase.

Such an arrangement allows a pertinent grouping of the proofs of purchase on the storage entity. Thus, when the storage entity is a user's terminal, that user can access proofs of purchase grouped for example according to the commercial name of the shop in which the purchase was made, such as it appears on the proof of purchase. The grouping can also be carried out according to other criteria extracted from the proof of purchase, such as for example the name of a product purchased, a date, an identifier of a company or any other desirable criterion.

According to a particular embodiment, at least a portion of the sending address of the message is selected according to the grouping criterion determined according to the at least one characteristic extracted from the proof of purchase. Most messaging applications make it possible to sort the received messages according to the sender's address in order to present them in the form of a conversation. By transmitting a message in which the address of the sender is entered according to a characteristic of a proof of purchase, the method allows an automatic grouping by the messaging application of the receipts corresponding to purchases made for example at a same shop. The management of the proofs of purchase is thus facilitated and the terminals equipped with instant messaging software do not necessitate any particular adaptation in order to group the proofs of purchase.

The grouping of the proofs of purchase according to a particular criterion makes it possible to apply specific subsequent processing, such as the calculation of a total expenditure in a particular shop for example.

According to a particular embodiment, the method is such that at least one characteristic extracted is the date and the amount of the transaction, the matching step being based on said date and said amount.

The collected proofs of purchase are analyzed in order to extract at least one characteristic from it, such as for example the amount of the transaction, its date, its beneficiary or furthermore the commercial name of the shop. It is thus possible to match a proof of purchase with a bank transaction on the user's account on the basis of the amount of the transaction and of its date for example.

According to a particular embodiment, the method is such that the collection step comprises the obtaining of an electronic receipt transmitted by a payment receiving device and/or by a terminal associated with the user.

The proofs of purchase can be transmitted by the user's terminal, for example by the intermediary of an instant message comprising a photograph of the proof of purchase taken by the user. The proofs of purchase can also be transmitted by a payment receiving device of the shop in the form of an electronic payment receipt, for example by e-mail or any other ad hoc transmission means.

In a way corresponding to the management method, the invention also relates to a method for archiving at least one proof of purchase on a communication terminal such that it comprises a step of receiving at least one message comprising a characteristic of a bank transaction and a representation of an associated proof of purchase, a step of obtaining a grouping criterion determined according to a characteristic extracted from the proof of purchase, and a step of storing the received proof of purchase according to the grouping criterion of the obtained proof of purchase.

The proofs of purchase are thus stored on the user's terminal in association with the corresponding bank transaction. The terminal obtains a grouping criterion making it possible to group proofs of purchase corresponding to such a criterion. The criterion can be obtained from the message, for example it can be comprise in the address of the sender of the message. The transmission address of such a message is configured according to a criterion extracted from the proof of purchase in question. In this way, the proofs of purchase received by the terminal are automatically grouped in the form of an instant messaging conversation in a form which is particularly intuitive for the user. The criterion can also be obtained by an analysis of the proof of purchase by the terminal, for example by an optical character recognition or a lexicographic analysis of the proof of purchase in order to extract a characteristic from it.

According to another aspect, the invention relates to a device for managing proofs of purchase noteworthy in that it comprises:
A collection module suitable for collecting at least one proof of purchase,
An analysis module suitable for extracting at least one characteristic of the purchase from the at least one proof of purchase collected,
An identification module suitable for identifying a bank transaction on a bank account of the user by matching the at least one extracted characteristic of the proof of purchase with a characteristic of a transaction on a bank account of the user,
A database, suitable for storing the proof of purchase in association with the transaction when a transaction is identified.

According to a particular embodiment, the management device comprises moreover a communication module suitable for transmitting a characteristic of the transaction and a representation of the associated proof of purchase to a user's terminal.

According to a particular embodiment of the management device, the collecting module is an image acquisition device associated with the device and/or a communication module suitable for receiving a proof of purchase transmitted through a communication network.

The invention also relates to a device for archiving at least one proof of purchase on a communication terminal such that it comprises a communication module suitable for receiving at least one message comprising a characteristic of a bank transaction carried out on a bank account of the user and a representation of an associated proof of purchase, a module for obtaining a grouping criterion determined according to a characteristic extracted from the proof of purchase, and a module for storing said proof of purchase in a memory of the terminal according to the grouping criterion.

The invention also relates to a terminal comprising an archiving device such as described above.

According to a particular embodiment, the invention relates to a server comprising a management device or a terminal comprising a management device such as described above.

In a particular embodiment, the different steps of the method according to the invention are determined by computer program instructions.

Consequently, the invention also relates to a computer program comprising instructions for the execution of the steps of the management method and/or the steps of the archiving method, when said program is executed by a processor.

Such a program can use any programming language whatsoever, and can be in the form of source code, object code, or intermediate code between source code and object code, such as in a partially compiled form, or in any other desirable form whatsoever.

Finally, the invention relates to an information medium that can be read by a processor in which is recorded a computer program comprising instructions for the execution of the steps of the management method and/or the instructions for the execution of the archiving method.

The information medium can be any entity or device whatsoever capable of storing the program. For example, the medium can comprise a storage means, such as a ROM, for example a CD ROM or a microelectronic circuit ROM, or it can be a magnetic recording means, for example a diskette (floppy disc) or a hard disk. Moreover, the information medium can be a transmittable medium such as an electrical or optical signal, which can be conveyed by an electric or optical cable, by radio or by other means. The program according to the invention can, in particular, be uploaded onto a network of the internet type. Alternatively, the information medium can be an integrated circuit in which the program is incorporated, the circuit being designed for executing or for being used in the execution of the method in question.

The abovementioned different ways or characteristics of embodiment can be added independently or in combination with each other, to the steps of the management and archiving methods such as defined above.

The servers, terminals, devices, programs and information media exhibit at least advantages analogous to those provided by the method to which they correspond.

### BRIEF DESCRIPTION OF THE FIGURES

Other features and advantages of the invention will appear more clearly on reading the following description of a particular embodiment, given as a simple, illustrative and non-limiting example, and the appended drawings among which:

FIG. 1 shows an architecture suitable for implementing the management method conforming with a particular embodiment,

FIG. 2 shows the different steps of the management method according to a particular embodiment,

FIG. 3 shows the architecture of an obtaining device according to a particular embodiment.

### DETAILED DESCRIPTION

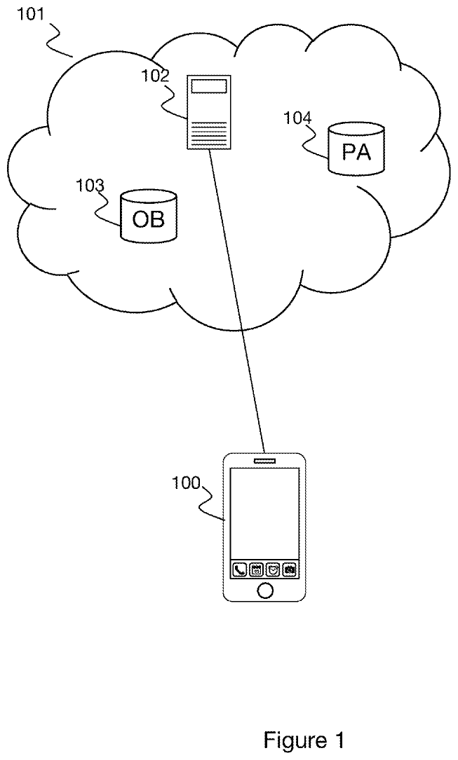

FIG. 1 shows an architecture suitable for implementing the management method according to a particular embodiment.

FIG. 1 shows a mobile communication terminal 100 suitable for being connected to a communication network 101. The terminal 100 is for example a mobile terminal of the smartphone type suitable for being connected to the communication network 101 by the intermediary of a cellular or Wi-Fi access network which is not shown. The network 101 is for example an IMS communication network (IMS standing for “IP Multimedia Subsystem”) comprising an application server 102 suitable for exchanging messages with the terminal 100 according to an instant messaging protocol conforming with the RCS (Rich Communication Service) standard.

FIG. 1 also shows a database 103 comprising recordings relating to bank transactions carried out on a bank account of the user of the terminal 100. Such recordings correspond for example to payments made by the user of the terminal 100 via a credit card, a contactless payment means or by a transfer. The database 103 can be part of a bank data system of a bank in which the user has an account. Thus, when the user makes a payment in a shop using his bank card for example, a recording is added to the database 103.

FIG. 1 also shows a database 104 in which are stored proofs of purchase corresponding to purchases made by the user of the terminal 100. For example, when the user of the terminal 100 makes a purchase in a shop, the shop delivers a proof of purchase. It is for example a till receipt, an invoice, a warranty card or any kind of receipt. Such a proof of purchase conventionally comprises the date of the purchase, the amount paid, and the subject of the purchase. The proofs of purchase stored in the database 104 are for example proofs of purchase obtained via the terminal 100 or transmitted by a shop's checkout system. They can be stored in any desirable form, such as for example in the form of an image captured by a camera or of a text document. The proofs of purchase are stored in the database 104 in association with an identifier of the user having made the payment. In this case, the proofs of purchase stored in the database 104 are associated with the user of the terminal 100, for example by using the telephone number of the terminal 100 as an identifier. Thus, it is possible for the server 102, for example by means of a suitable SQL (Structured Query Language) query, to obtain proofs of purchase associated with the user of the terminal 100.

The server 102 can also obtain, from the database 103, information relating to bank transactions carried out by the user of the terminal 100. For this purpose, the bank transactions of the database 103 are stored in association with the telephone number of the terminal 100. Thus, from the telephone number of the terminal 100, the server 102 can obtain both proofs of purchase and bank transactions associated with the user.

According to the invention, when the server 102 detects the addition of a new proof of purchase in the database 104, it searches for a corresponding transaction in the database of bank transactions 103. In order to do this, the server 102 carries out an analysis of the proof of purchase in order to extract data from it. Such an analysis comprises for example an optical character recognition when the proof of purchase is in the form of an image. When the proof of purchase is in a format which is adapted for being analyzed, for example in a text format, the extraction of characteristics from the proof of purchase is carried out. The extraction of characteristics comprises for example searching for the date of the purchase and its amount. The extraction step can also allow the server 102 to obtain the object of the purchase, that is to say for example the description, the quantity and the unit price of the purchased goods.

The bank transactions accounted for on a bank account generally comprise at least a date and an amount. Thus, on the basis of the date and of the amount of a purchase obtained from a proof of purchase stored in the database 104, the server 102 searches for a corresponding transaction in the database 103, that is to say one having the same date and the same amount. When a corresponding transaction is identified, the server stores the correspondence in order to be able to provide the user with the proof of purchase associated with the bank transaction. Thus, the user has proofs of purchase associated with the bank transactions recorded on his account, which facilitates their management by the user.

According to a particular embodiment, the server 102 transmits to the terminal a representation of the proof of purchase in association with a characteristic of the associated bank transaction. For example, after a bank transaction of the user has been identified by the matching of the at least one extracted characteristic of the proof of purchase with a characteristic of the transaction on a bank account of the user, the server 102 sends an instant message to the terminal 100. The message sent comprises, for example, the date of the transaction, its amount and a digital representation of the corresponding till receipt.

According to a particular embodiment, the message by which the server 102 transmits the proof of purchase and a characteristic of the transaction to the terminal is configured in such a way that it is grouped, during its display by the terminal, with other messages sharing a common characteristic. For example, the message is configured in such a way that it is grouped with other received messages relating to a transaction carried out in a same shop. The grouping corresponding for example to a view in the form of a conversation with the shop. For this purpose, the server 102 configures a particular sender identifier in the instant message. For example, when the message transmitted by the server 102 is an SIP message, the “from” header of the message is configured with a URI (Universal Resource Identifier) and/or a “Display Name” corresponding to the characteristic according to which the message is grouped, for example an identifier of the shop in which a purchase was made. In this way, the proofs of purchase corresponding to purchases made in a same commercial establishment are grouped on the terminal within a same instant messaging conversation.

According to a particular embodiment, the management method can be implemented by the terminal 102.

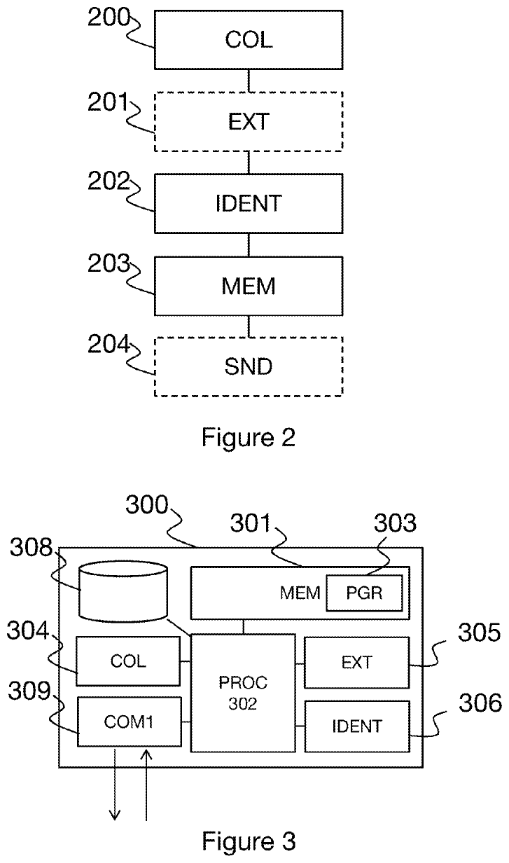

The steps of the management method will now be described in detail, in a particular embodiment, with reference to FIG. 2.

In a first step 200, the collection of at least one proof of purchase is carried out. For this purpose, according to a first embodiment, the server 102 obtains at least one proof of purchase from a database such as the database 104 shown in FIG. 1. This database can correspond to an email account of the user to which proofs of purchase are sent by a checkout system of a commercial establishment. For example, the user can have a loyalty card with a shop due to which the proofs of purchase are sent by the shop to an email address given by the user during the creation of his card. The collection of the proofs of purchase can then take place through access to the corresponding email account in order to search it for messages comprising proofs of purchase. For this purpose, the server 102 accesses an electronic messaging account using authentication data previously provided by the user. The identification of messages comprising proofs of purchase is carried out for example by analyzing the content of the messages according to known extraction techniques in order to detect in them key words characteristic of a transaction such as “invoice”, “order”, etc. . . . . In order to identify messages likely to comprise proofs of purchase more precisely, the server 102 can access a database comprising bank transactions of the user, such as for example the database 103. From the database 103, the server determines dates on which transactions took place and the amount of such transactions and searches from among the messages received on the user's email account for messages comprising such a date and such an amount. When corresponding messages are identified, the proofs of purchase which they contain are collected.

According to a particular embodiment, the proofs of purchase are collected in the terminal 100. When the server determines that a new bank transaction takes place on a bank account of the user, it transmits a message to the terminal for the purpose of obtaining the corresponding proof of purchase. In order to do this, the server 102 transmits for example an instant message conforming with an instant messaging protocol comprising a message inviting the user to photograph and transmit the till receipt corresponding to the detected transaction. According to a particular embodiment, the payment is made in a contactless manner using an NFC (Near Field Communication) module of the terminal and the terminal automatically obtains a proof of the purchase which it transmits to the server 102 by means of a suitable message.

According to a particular embodiment, the server 102 collects proofs of purchase by the intermediary of a mediation server of a bank data system having the task of collecting proofs of purchase from different sources.

In step 201, the server 102 analyzes the collected proofs of purchase in order to extract characteristic information from them. In particular the server 102 carries out the extraction of the date appearing on the proof of purchase and its amount. Such an extraction is carried out according to known techniques adapted to the format of the proof of purchase. For example, when the proof of purchase is a digitized image, the extraction comprises for example an analysis by optical character recognition and then a search for a date, a time and an amount from regular expressions configured in such a way as to allow the recognition of character strings corresponding to the date, the time and/or the amount appearing on the proof of purchase. When the proof of purchase is a structured file, such as for example a file in XML format, known analysis techniques adapted to the structured file format are used for the same purpose. For example, the server can use an XML DOM (Document Object Model) analyzer.

In a step 202, the server identifies a bank transaction on a bank account of the user by matching the at least one extracted characteristic of the proof of purchase with a characteristic of a transaction on a bank account of the user. In order to do this, from data extracted from a proof of purchase, such as for example the amount, the date and the time of a purchase, the server 102 searches in a database of bank transactions, such as the database 103, for a corresponding transaction, that is to say a transaction whose date, time and amount correspond to the date, the time and the amount extracted from the proof of purchase. Other characteristics can be used in order to match a proof of purchase and a bank transaction. For example, the type of payment means used, the commercial name or the bank identity of the shop can be used for matching a proof of purchase with a bank transaction when they appear on the proof of purchase. According to a particular embodiment, the server can extract an expiry date associated with the proof of purchase. For example, when the proof of purchase is a discount coupon or a credit note, it can comprise an end of validity date. The server 102 can then program the transmission of a reminder message to the user's terminal when the end of validity date determined from the analysis of the proof of purchase becomes close, for example one week before its expiry. The management of discount coupons or credit notes is thus facilitated.

When a transaction is identified during the matching step 202, the server 102 stores the proof of purchase in association with the corresponding bank transaction in a database in a step 203. In this way, a user can obtain proofs of purchase associated with his bank transactions at any time.

According to a particular embodiment, the method comprises a step 204 during which is carried out the transmission, by the server, of a characteristic of a bank transaction and of a representation of the associated proof of purchase. Thus, when a user makes a purchase in a shop using an electronic payment means such as a bank card or a mobile telephone equipped with a contactless payment system, he can immediately receive, from the server 102, an instant message comprising a summary of his purchase, that is to say the data of the bank transaction in association with the data contained in the proof of purchase. The management of the proofs of purchase, and in particular searching for them and the associated accounting is thus facilitated.

According to a particular embodiment, the steps of collection 200, extraction 201, identification of a bank transaction 202 and storage 203 of a proof of purchase in association with a bank transaction are carried out by a terminal, such as for example by the terminal 100 in FIG. 1. In such a case, the terminal obtains for example bank transactions from a bank server. With regard to the proofs of purchase, these are collected by the terminal, for example from an image captured by a camera of the terminal, or from a server. The terminal therefore comprises a database in which are stored the proofs of purchase in association with bank transactions. Such a database can for example be a database intended for storing instant messages received by an instant messaging application, or any other database on the terminal or accessible from the terminal.

According to a particular embodiment, the server 102 comprises a conversational agent of the “chatbot” type suitable for exchanging messages in natural language with the terminal 100 conforming with an instant messaging protocol. The conversational agent notably transmits, in step 204, the message comprising a characteristic of the transaction and a representation of the associated proof of purchase. Such a conversational agent is moreover suitable for receiving messages coming from the terminal 100, such as messages comprising commands for grouping proofs of purchase according to a particular criterion. Such messages comprise commands formulated in natural language by the user and interpreted by the conversational agent of the server 102. For example, the user can formulate a command to obtain statistics on the purchases that he has made in the corresponding shop, a command for deleting the purchase information that has become obsolete, a command for obtaining details on the after-sales service corresponding to a particular purchase, etc.

According to another aspect, and in a way corresponding to the management method, the invention relates to a method of archiving proofs of purchase in a communication terminal such as the terminal 102. The steps of the archiving method are described with reference to FIG. 4 and comprise a step 400 of receiving at least one message comprising at least one characteristic of a bank transaction and a representation of an associated proof of purchase, a step 401 of obtaining a grouping criterion coming from a characteristic extracted from the proof of purchase and a step 402 of storing said representation of the proof of purchase in association with the at least one characteristic of the bank transaction. The grouping identifier is determined according to a characteristic extracted from the proof of purchase in such a way as to offer the user a grouping of the proofs of purchase which is pertinent. It can be obtained by an analysis of the proof of purchase received as described above, or from the received message. In particular, the grouping identifier can be, according to a particular embodiment, the address field of the sender given in the message. Such an address is then selected according to a characteristic extracted from the proof of purchase in such a way that, for example, proofs of purchase relative to a same shop are automatically grouped. Most instant messaging software and applications automatically group the messages according to the address of the sender. Such an arrangement allows an automatic grouping of the proofs of purchase in an instant messaging conversation. The user can thus more easily find the proofs of purchase and the terminal does not need to be specifically adapted.

According to a particular embodiment of the archiving method, the method comprises moreover a step of obtaining a second characteristic extracted from at least one proof of purchase and a step of transmitting, to a device for managing proofs of purchase according to the invention, a message comprising a grouping command according to said second extracted characteristic. The terminal can obtain the second extracted characteristic from a message sent by a device for managing proofs of purchase comprising at least a second characteristic which can be used for grouping proofs of purchase. For example, it can be a date or the identifier of a product appearing on the proof of purchase, or a geographic location of the shop in which the purchase was made.

According to a particular embodiment, the archiving method comprises moreover steps of obtaining a characteristic extracted from a proof of purchase, of searching for corresponding characteristics among a set of proofs of purchase stored on the terminal, of selection of the proofs of purchase whose characteristics correspond, and of display of said proofs of purchase whose characteristics correspond grouped according to the extracted characteristic. Such an arrangement allows the application of processings on a set of proofs of purchase having a common characteristic. This makes it possible, for example, to calculate a total of spending carried out for a particular product, at a particular shop or on a particular date.

According to a particular embodiment of the archiving method, the method can comprise a step of transmitting a command to a device for managing proofs of purchase, the command comprising for example an instruction suitable for causing the deletion of a proof of purchase from the storage device in which it is stored.

According to a particular embodiment, the grouping of proofs of purchase according to a second criterion extracted from a proof of purchase is carried out by the terminal on which the archiving method is implemented.

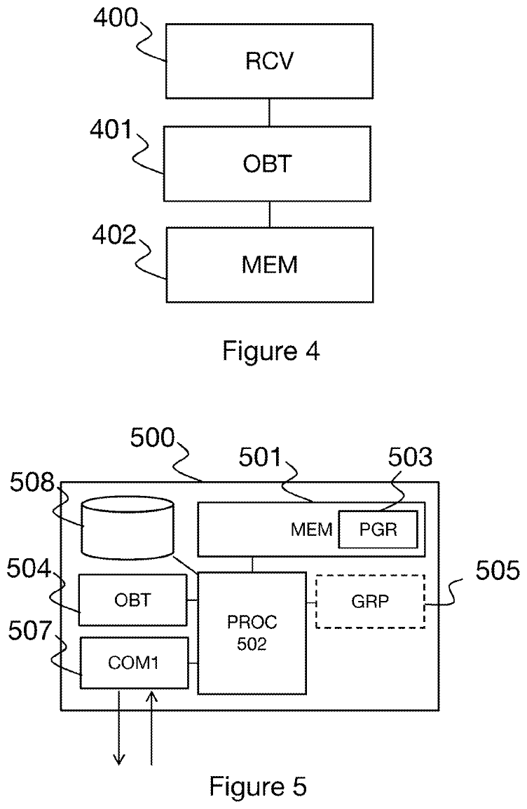

FIG. 3 shows the architecture of a device 300 suitable for implementing the management method according to the invention.

The device comprises a storage space 301, for example a memory MEM, a processing unit 302 equipped for example with a processor PROC. The processing unit can be controlled by a program 303, for example a computer program PGR, implementing the management method such as described in the invention with reference to FIG. 2, and notably the steps of collecting at least one proof of purchase, of extracting at least one characteristic of the purchase from the at least one proof of purchase collected, of identifying a bank transaction on a bank account of the user by matching the at least one extracted characteristic of the at least one proof of purchase with a characteristic of a transaction on a bank account of the user, and, when a transaction is identified, of storing the proof of purchase in a database in association with the transaction. According to a particular embodiment, the computer program implements a step of transmitting to a terminal of the user, a characteristic of the transaction and a representation of the associated proof of purchase.

On initializing, the instructions of the computer program 303 are for example loaded into a RAM (Random Access Memory in English) memory before being executed by the processor of the processing unit 302. The processor of the processing unit 302 implements the steps of the management method according to the instructions of the computer program 303.

In order to do this, in addition to the memory 301 and the processor 302, the device comprises a collecting module (304, 309) suitable for collecting at least one proof of purchase. The collecting module is for example a communication interface 309 suitable for receiving a proof of purchase transmitted by a terminal or a mediation server through a communication network. It can be an Ethernet network interface or a wireless network interface of the WiFi, 2G, 3G or 4G type. According to a particular embodiment, the collecting module can be a module for accessing a database containing proofs of purchase on the basis of a suitable SQL query. According to a particular embodiment, the collecting module is a video acquisition device, such as a camera capable of capturing images, and in particular of digitizing paper proofs of purchase.

The device 300 comprises moreover an analysis module 305 suitable for extracting at least one characteristic of a purchase from the at least one proof of purchase collected by the collecting module. The analysis module 305 can be used by the processing unit 302 executing computer program instructions configured for carrying out optical character recognition and/or instructions configured for searching for particular keywords, dates or amounts in suitable regular expressions.

The device 300 also comprises an identification module 306 suitable for identifying a bank transaction on a bank account of the user by matching the at least one characteristic of the proof of purchase extracted by the analysis module 305 with a characteristic of a transaction on a bank account of the user. The module 306 can be used by a computer program comprising instructions configured for comparing at least one characteristic of a proof of purchase extracted by the analysis module with at least one characteristic of a bank transaction.

A database (308), suitable for storing the proof of purchase in association with an identified transaction when a transaction is identified. The database is for example a relational database suitable for being interrogated by means of SQL queries.

According to a particular embodiment, the communication interface 309 is suitable for transmitting a characteristic of the transaction and a representation of the associated proof of purchase to a terminal of the user.

According to a particular embodiment, the device 300 is integrated in an instant messaging server or an application server of an IMS communication network.

According to a particular embodiment, the device 300 is integrated in a communication terminal.

FIG. 5 shows the architecture of a device 500 suitable for implementing the archiving method according to the invention.

The device comprises a storage space 501, for example a memory MEM, a processing unit 502 equipped for example with a processor PROC. The processing unit can be controlled by a program 503, for example a computer program PGR, implementing the archiving method such as described in the invention with reference to FIG. 4, and notably the steps of receiving at least one message comprising a characteristic of a bank transaction and a representation of an associated proof of purchase, of obtaining a grouping criterion determined according to a characteristic extracted from the proof of purchase, and of storing the obtained proof of purchase according to the grouping criterion.

On initializing, the instructions of the computer program 503 are for example loaded into a RAM (Random Access Memory in English) memory before being executed by the processor of the processing unit 502. The processor of the processing unit 502 implements the steps of the management method according to the instructions of the computer program 503.

In order to do this, the device comprises a communication module 507 suitable for receiving at least one message comprising a characteristic of a bank transaction and a representation of an associated proof of purchase, the message comprising a grouping criterion determined according to a characteristic extracted from the proof of purchase. Such a communication module is for example a WiFi network interface, or a cellular network interface of the 2G, 3G or 4G type, or an NFC (Near Field Communication) or Bluetooth communication interface. According to a particular embodiment, the communication module is suitable for exchanging messages with a server according to an instant messaging protocol, such as for example a protocol conforming with the RCS standard.

The device 500 also comprises a database 508 suitable for storing proofs of purchase associated with at least one characteristic of a bank transaction on a bank account of the user of the device and at least one characteristic extracted from said proof of purchase. The database module 508 is for example a database of an instant messaging application suitable for storing messages comprising a representation of a proof of purchase and a characteristic of an associated bank transaction, the storing being carried out according to a grouping criterion extracted from the proof of purchase.

In a particular embodiment, the device 500 comprises moreover a grouping module 505, suitable for grouping proofs of purchase according to at least one criterion extracted from a proof of purchase. Such a module can be used by a processor such as the processor PROC of the processing unit 502 and by computer program instructions executed by the processing unit 502 and configured for obtaining a characteristic extracted from a proof of purchase, searching for corresponding characteristics among a set of proofs of purchase, and selecting proofs of purchase whose characteristics match.

According to a particular embodiment, the archiving device comprises a module (504) for obtaining a grouping criterion determined according to a characteristic extracted from the proof of purchase. According to a particular embodiment, such a module is used by computer program instructions configured for analysis of a message coming from a server, the message comprising a grouping criterion determined according to a characteristic extracted from the proof of purchase determined by the server. The instructions can be stored in the memory 501 of the device and executed by the processor PROC of the processing unit. According to a particular embodiment, the instructions are configured for carrying out an analysis of the proof of purchase comprised in the message and extracting a grouping criterion from it.

According to a particular embodiment, the device 500 is integrated in a communication terminal such as a smartphone, a connected object, a tablet or a personal computer.

1. A method for managing proofs of purchase performed by a managing device and comprising:
collecting at least one proof of purchase;
extracting at least one characteristic of the purchase from the at least one proof of purchase collected;
identifying a bank transaction on a bank account of a user by matching the at least one extracted characteristic of the at least one proof of purchase with a characteristic of a bank transaction on a bank account of the user; and
in response to a transaction being identified, storing the proof of purchase in association with the transaction in a database on a non-transitory computer-readable medium.

2. The method as claimed in claim 1, further comprising transmitting, to a terminal of the user, of a characteristic of the transaction and of a representation of the associated proof of purchase.

3. The method as claimed in claim 2, wherein the transmitting comprises transmitting a message according to an instant messaging protocol.

4. The method as claimed in claim 2, wherein the message transmitted to the terminal comprises a grouping criterion determined according to the at least one characteristic extracted from the proof of purchase.

5. The method as claimed in claim 1, wherein the at least one characteristic extracted is the date and the amount of the transaction, the matching being based on said date and said amount.

6. The method as claimed in claim 1, wherein the at least one proof of purchase is obtained by the managing device from a terminal of the user and/or from a payment receiving device.

7. A method comprising:
archiving at least one proof of purchase on a communication terminal, comprising:
receiving at least one message comprising a characteristic of a bank transaction and a representation of an associated proof of purchase;
obtaining a grouping criterion determined according to at least one characteristic extracted from the proof of purchase; and
storing the obtained proof of purchase according to the grouping criterion on a non-transitory computer-readable medium.

8. A device for managing proofs of purchase, comprising:
a database;
a processor; and
a non-transitory computer-readable medium comprising instructions stored thereon which when executed by the processor configure the device for managing to:
collect at least one proof of purchase,
extract at least one characteristic of the purchase from the at least one proof of purchase collected,
identify a bank transaction on a bank account of a user by matching the at least one extracted characteristic of the proof of purchase with a characteristic of a transaction on a bank account of the user, and
store in the database the proof of purchase in association with the transaction in response to the transaction being identified.

9. The device as claimed in claim 8, wherein the device for managing is configured by the instructions to collect the proof of purchase from at least one of an image acquisition device associated with the device or a communication module suitable for receiving the proof of purchase transmitted through a communication network.

10. The device as claimed in claim 8, wherein the device comprises a communication module suitable for transmitting a characteristic of the transaction and a representation of the associated proof of purchase to a user's terminal.

11. A device for archiving at least one proof of purchase on a communication terminal, wherein the device comprises:
a processor; and
a non-transitory computer-readable medium comprising instructions stored thereon which when executed by the processor configure the device to:
receive at least one message comprising a characteristic of a bank transaction carried out on a bank account of a user and a representation of an associated proof of purchase;
obtain a grouping criterion determined according to at least one characteristic extracted from the proof of purchase; and
store said proof of purchase in a memory of the terminal according to the grouping criterion.

12. The device according to claim 8, wherein the device is comprises on a server for managing proofs of purchase.

13. The device according to claim 8, wherein the device is comprised on a terminal for managing proofs of purchase.

14. (canceled)

15. A non-transitory information medium, that can be read by a processor, in which is recorded a computer program comprising instructions for execution of a method for archiving at least one proof of purchase on a communication terminal when the instructions are executed by a processor of the communication terminal, the instructions configuring the communication terminal to:
receive at least one message comprising a characteristic of a bank transaction and a representation of an associated proof of purchase;
obtain a grouping criterion determined according to at least one characteristic extracted from the proof of purchase; and
store the obtained proof of purchase according to the grouping criterion on a non-transitory computer-readable medium.

16. The method as claimed in claim 3, comprising:
creating a sender address comprising a grouping criterion determined according to the at least one characteristic extracted from the proof of purchase; and
transmitting a message to the terminal with the created sender address.

17. The method as claimed in claim 16, wherein a field of the sender address comprises a grouping criterion determined from first and second extracted characteristics.

18. The method as claimed in claim 16, wherein an extracted characteristic of the proof of purchase is the date of the purchase, an identifier of the product purchased, an identifier of the shop or the geographic location of the shop in which the purchase was made.

19. The method as claimed in claim 7, wherein the grouping criterion is received via a field of a sender address of the at least one message.

20. The method as claimed in claim 19, wherein the method comprises:
grouping received messages according to their sender address.

21. The method as claimed in claim 19, wherein the sender address field comprises a grouping criterion determined from a first extracted characteristic.

22. The method as claimed in claim 19, wherein the sender address field comprises a grouping criterion determined from first and second extracted characteristics.

23. The method as claimed in claim 7, wherein an extracted characteristic of the proof of purchase is the date of the purchase, an identifier of the product purchased, an identifier of the shop or the geographic location of the shop in which the purchase was made.
